(19) United States
(12) Patent Application Publication
(10) Pub. No.: US 2011/0291036 A1
(43) Pub. Date: Dec. 1, 2011

(54) VALVE DRIVING DEVICE

(75) Inventors: Tetsuji YAMANAKA, Obu-city (JP); Hiroki Shimada, Anjo-city (JP); Tetsuma Takeda, Kariya-city (JP)

(73) Assignee: DENSO CORPORATION, Kariya-city (JP)

(21) Appl. No.: 13/109,309

(22) Filed: May 17, 2011

(30) Foreign Application Priority Data
May 31, 2010 (JP) 2010-124435

(51) Int. Cl. F16K 31/44

(52) U.S. Cl. 251/251

(57) ABSTRACT

A valve driving device to open or close a valve includes a cam having a cam groove, a follower movably fitted in the cam groove, and a rod having a pivot rotatably supporting the follower. The rod has a first end connected to the cam through the follower and the pivot, and a second end connected to the valve. The rod applies a load to the valve in a load applying direction corresponding to an axis direction of the rod. A center axis of the rod is perpendicular to a tangent of a contact face between which the cam and the follower are contact with each other when the valve is totally closed or opened.

### CROSS REFERENCE TO RELATED APPLICATION

This application is based on Japanese patent application No. 2010-124435 filed on May 31, 2010, the disclosure of which is incorporated herein by reference in its entirety.

### BACKGROUND OF THE INVENTION

1. Field of the Invention

The present invention relates to a valve driving device.

2. Description of Related Art

WO2009/062928 describes an electric actuator to drive a valve, and the electric actuator is shown in FIGS. 6 and 7. The electric actuator includes an electric motor 101, a rod 102 to reciprocate in an axis direction, a deceleration mechanism, a slider link mechanism and a bearing 103. The deceleration mechanism decelerates a rotation of the motor 101 by two-step. The slider link mechanism converts a rotating movement of the deceleration mechanism into a linear movement of the rod 102. The bearing 103 reciprocatably supports the rod 102.

The deceleration mechanism has a pinion gear 104, a middle gear 105 and a final gear 106. The pinion gear 104 is fixed to an output shaft of the motor 101. The middle gear 105 is rotated by being engaged with the pinion gear 104. The final gear 106 is rotated by being engaged with the middle gear 105. The middle gear 105 is rotatably attached to a supporting shaft 111. The final gear 106 is rotatably attached to a supporting shaft 112.

A toggle lever 107 is connected to the rod 102 through a first pivot 113, and is connected to the final gear 106 through a second pivot 114. The first pivot 113 is fixed to the toggle lever 107 by being fitted into a first hole of the toggle lever 107. The second pivot 114 is fixed to the toggle lever 107 by being fitted into a second hole of the toggle lever 107. When the motor 101 rotates the gears 104, 105, 106, the toggle lever 107 pushes or pulls the rod 102 in the axis direction. Thus, the rotating movement of the final gear 106 is converted into a reciprocation linear movement of the rod 102, so that a poppet valve 108 having a disk shape is opened or closed by the electric actuator.

A linear line L101 is defined to connect a rotation center C1 of the final gear 106 to a rotation center C2 of the second pivot 114. A linear line L102 is defined to connect the rotation center C2 of the second pivot 114 to a rotation center C3 of the first pivot 113. An intersecting angle θ defined between the line L101 and the line L102 is set to have an acute angle)(<90°. Thereby, a link efficiency is improved when the valve 108 is totally closed. However, the link efficiency is not the maximum because the linear line L1 is not coincident with a load applying direction of the rod 102.

Because the electric actuator has the slider link mechanism, the link efficiency is raised at a totally-closed position at which the valve 108 is totally closed, so that a motor current can be reduced. However, in contrast, the link efficiency is decreased at a totally-opened position at which the valve 108 is totally opened, so that the rod 102 may apply a further load onto the toggle lever 107 when the valve 108 is totally opened. In this case, a predetermined current is necessary for stopping the valve 108 at the totally-opened position, so that a consumption electricity is increased when the valve 108 is totally opened.

A waste gate valve is arranged in an exhaust passage of an internal combustion engine having a turbocharger. The waste gate valve opens or closes a bypass passage which bypasses a turbine of the turbocharger, so that a supercharging pressure or an exhaust gas pressure can be maintained within a predetermined range. When the electric actuator is used for driving the waste gate valve, the valve is frequently opened or closed between the totally-closed position and the totally-opened position. In this case, because the predetermined current is necessary when the valve is totally opened, the consumption electricity is increased.

### SUMMARY OF THE INVENTION

In view of the foregoing and other problems, it is an object of the present invention to provide a valve driving device.

According to an example of the present invention, a valve driving device to open or dose a valve includes a motor; a deceleration mechanism to slow down a rotation of the motor; a cam to be rotated with a rotation of the deceleration mechanism; a follower; and a rod. The cam has a cam groove having a predetermined shape corresponding to an operation pattern of the valve. The follower is movably fitted into the cam groove. The rod has a pivot rotatably supporting the follower. The rod has a first end connected to the cam through the follower and the pivot, and a second end connected to the valve. The rod reciprocates in an axis direction, and applies a load to the valve in a load applying direction corresponding to the axis direction. The rod has a center axis approximately perpendicular to a tangent of a contact face between which the cam and the follower are contact with each other when the valve is totally closed or opened.

Accordingly, consumption electricity of the valve driving device can be reduced.

### BRIEF DESCRIPTION OF THE DRAWINGS

The above and other objects, features and advantages of the present invention will become more apparent from the following detailed description made with reference to the accompanying drawings. In the drawings:

FIG. 1 is a view illustrating an electric actuator according to a first embodiment of the present invention when a valve is totally closed;

FIG. 2 is a cross-sectional view illustrating the electric actuator when the valve is totally closed;

FIG. 3 is a view illustrating the electric actuator when the valve is totally opened;

FIG. 4 is a cross-sectional view illustrating the electric actuator when the valve is totally opened;

FIG. 5 is a view illustrating an electric actuator according to a second embodiment of the present invention when a valve is totally closed;

FIG. 6 is a front view illustrating a conventional electric actuator; and

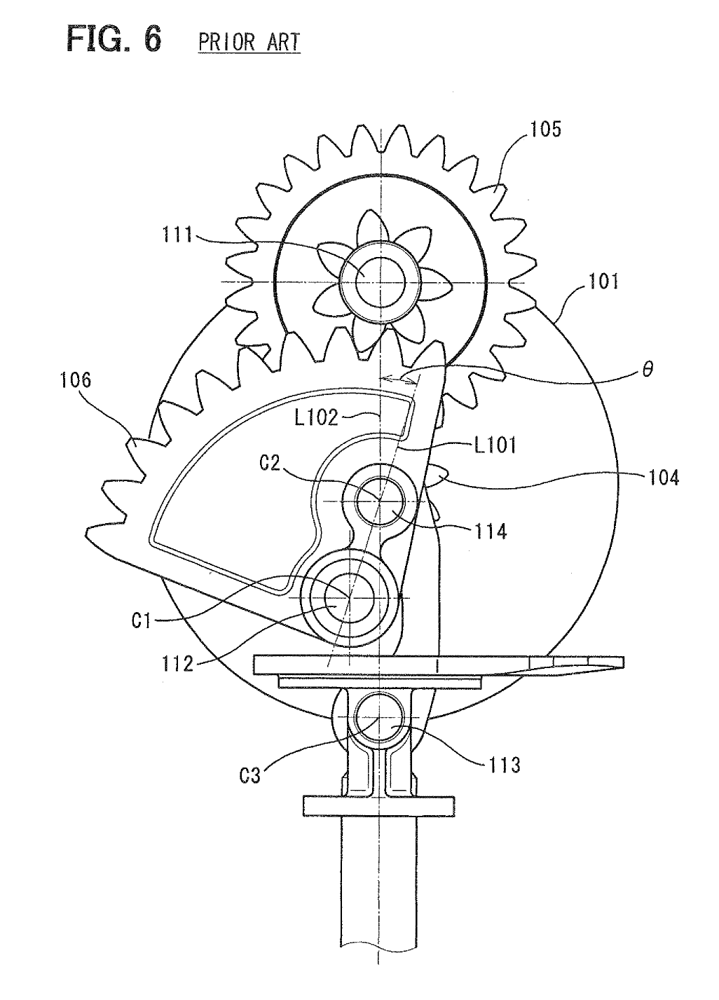

FIG. 7 is a side view illustrating the conventional electric actuator.

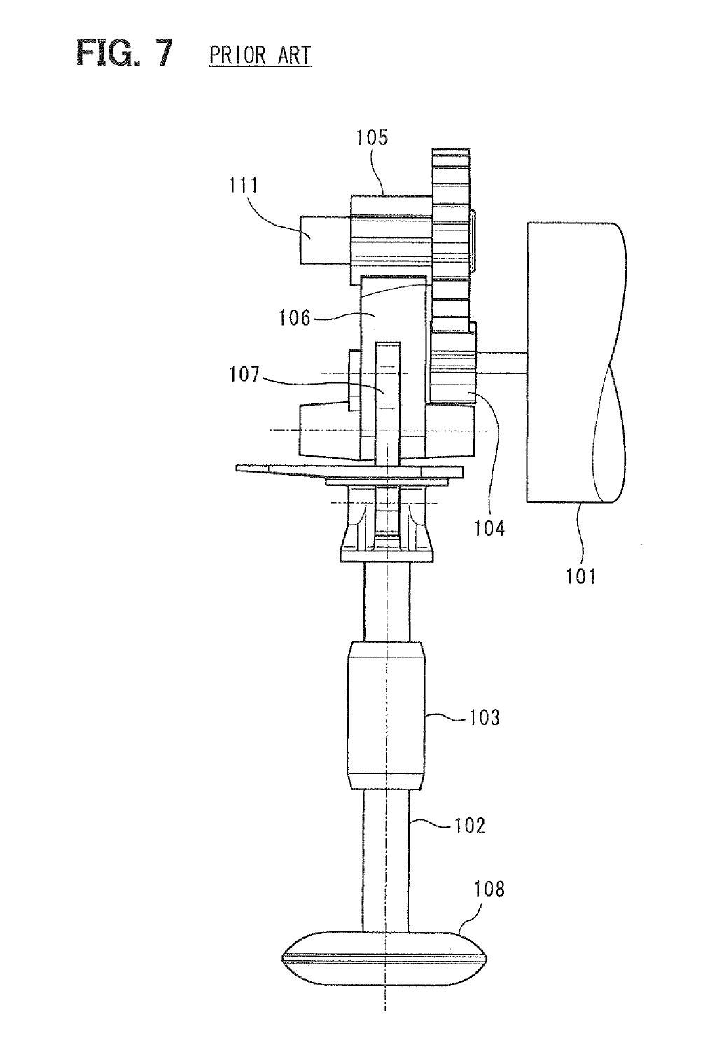

### DETAILED DESCRIPTION OF PREFERRED EMBODIMENT

### First Embodiment

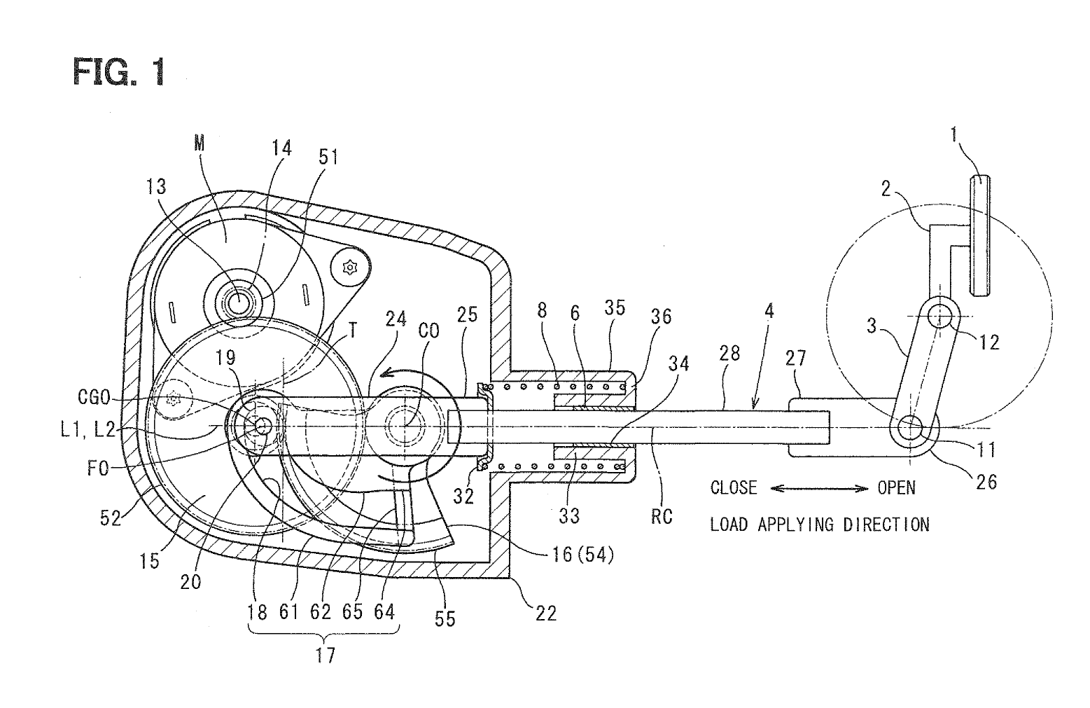

A first embodiment will be described with reference to FIGS. 1-4.

A valve driving device corresponds to an electric actuator that opens or closes a waste gate valve 1, and the valve 1 corresponds to a hinge valve, as shown in FIG. 1. The waste gate valve 1 is a valve member of an exhaust controlling valve that opens or closes a waste gate passage defined in a turbocharger disposed in an internal combustion engine.

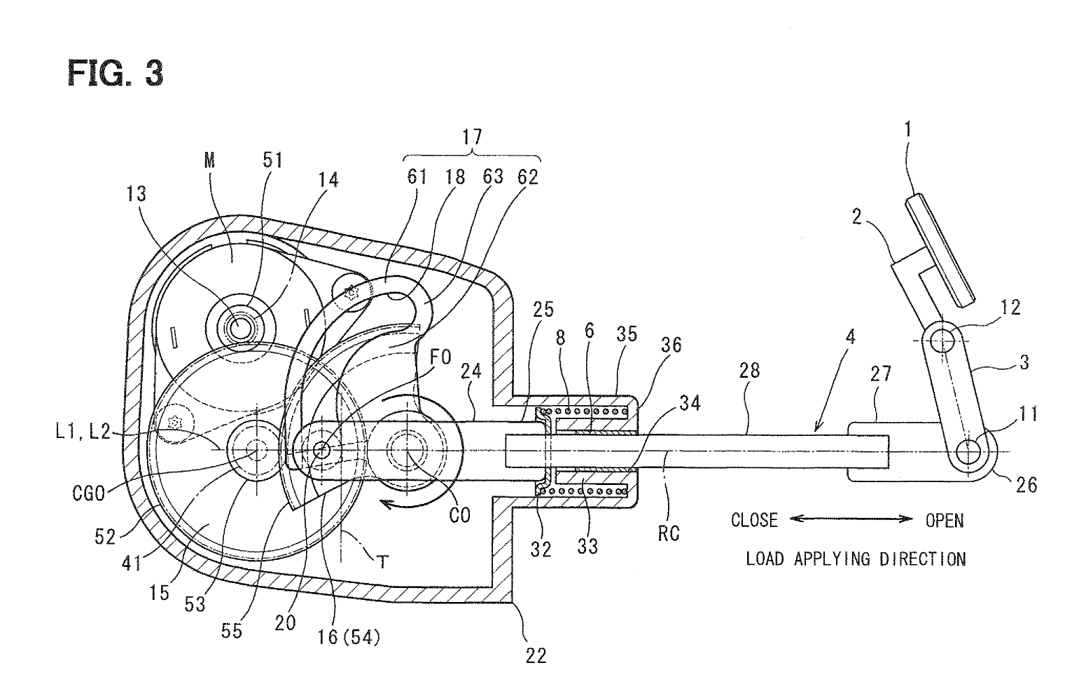

While the engine is active, the valve 1 is controlled by a control signal output from an electronic control unit (ECU) of the engine. The valve 1 is controlled to move within an operation range defined between a totally-closed position shown in FIG. 1 and a totally-opened position shown in FIG. 3. A passage area of exhaust gas is changed by controlling an open area of the waste gate passage.

An L-shaped shaft 2 is integrally arranged on a back face of the valve 1. The valve 1 has a seat face to be seated on a valve seat (not shown), and the back face is located opposite from the seat face. Details of the waste gate valve 1 are mentioned later.

The electric actuator has a rod 4 connected to the shaft 2 through a link lever 3 corresponding to a link mechanism. The rod 4 reciprocates in an axis direction of the rod 4, and the axis direction corresponds to a load applying direction of the rod 4. The electric actuator opens or closes the valve 1 in accordance with a movement (stroke) amount of the rod 4 in the load applying direction.

The electric actuator further includes a rod (thrust) bearing 6, a coil spring 8 and an actuator case. The bearing 6 slidably supports the rod 4 in a reciprocating direction corresponding to the load applying direction. The coil spring 8 generates a biasing force (spring load) biasing the rod 4 in a direction of closing the valve 1. The actuator case accommodates components of the actuator. A tip end portion of the rod 4 protrudes outward from a ring-shaped end face of the actuator case. Details of the electric actuator are mentioned later.

As shown in FIGS. 1-4, when the rod 4 is moved leftward in the load applying direction, the valve 1 is closed. When the rod 4 is moved rightward in the load applying direction, the valve 1 is opened.

The engine is a diesel engine having plural cylinders. An intake pipe is connected to each suction port of the cylinder, and intake air flows through the intake pipe. A compressor of the turbocharger, an intercooler, a throttle valve, and an intake manifold are disposed in the intake pipe.

An exhaust pipe is connected to each exhaust port of the cylinder, and exhaust gas flows through the exhaust pipe. A turbine of the turbocharger and an exhaust manifold are disposed in the exhaust pipe.

The turbocharger has the turbine and the compressor. Intake air is compressed by the compressor, and the compressed air is sent into a combustion chamber of the cylinder. The turbine has a turbine housing having a spiral shape, and a turbine impeller (turbine wheel) is disposed in the turbine housing. The compressor has a compressor housing having a spiral shape, and a compressor impeller (compressor wheel) is disposed in the compressor housing. The turbine impeller and the compressor impeller are connected with each other by a rotor shaft so as to have integral rotation. When the turbine impeller is rotated by exhaust gas, the compressor impeller is also rotated so as to compress intake air.

A waste gate passage is defined in the turbine housing of the turbocharger. Due to the waste gate passage corresponding to a fluid bypass channel, exhaust gas introduced into the turbine housing bypasses the turbine impeller, and flows into an exhaust passage downstream of the turbine impeller. Alternatively, the waste gate passage may bypass the turbine housing. In this case, exhaust gas flowing out of the engine is branched downstream of a gather part of the exhaust manifold, and the branched gas is joined to the intake passage downstream of the turbine.

An upstream communication hole (waste gate port) opens in a separation wall of an inlet portion of the turbine housing, and a downstream communication hole opens in a separation wall of an outlet portion of the turbine housing. The waste gate passage makes the upstream hole and the downstream hole to communicate with each other.

The waste gate valve 1 has a disk shape, and is made of metal material such as stainless steel. The waste gate valve 1 is connected to the tip end portion of the rod 4, and is seated on or separated from the separation wall (valve seat) of the inlet portion of the turbine housing. The valve 1 is an exhaust gas controlling valve which opens or closes the waste gate port of the waste gate passage.

A link mechanism is arranged between the shaft 2 and the rod 4. A linear movement of the rod 4 is converted into a rotating movement of the valve 1 by the link mechanism. As shown in FIG. 1, the link mechanism includes the link lever 3 having a first end connected to the tip end portion of the rod 4, and a second end connected to the shaft 2.

A first hinge pin 11 is fixed to or integrally formed with the tip end portion of the rod 4. The pin 11 passes through the rod 4, and protrudes from a face of the rod 4. A second hinge pin 12 is integrally formed with or fixed to the shaft 2, and protrudes in the same direction as the first hinge pin 11.

The link lever 3 is supported to be rotatable around the first hinge pin 11, so that the first hinge pin 11 rotatably supports the waste gate valve 1, the link lever 3 and the shaft 2. Further, the link lever 3 is fixed to the second hinge pin 12, and the second hinge pin 12 is fixed to the L-shaped shaft 2. The second hinge pin 12 is rotatably supported by a side wall of the turbine housing of the turbocharger. A center of the second hinge pin 12 corresponds to a rotation center of the waste gate valve 1. The valve 1 is a hinge valve connected to the tip end portion of the rod 4 through the first hinge pin 11, the link lever 3 and the second hinge pin 12.

The electric actuator further includes an electric motor M, a deceleration mechanism to decelerate a rotation of the motor M by two-step, and a converter to convert a rotation movement of the deceleration mechanism into a reciprocation linear movement of the rod 4.

The deceleration mechanism has a pinion (motor) gear 14, a middle (first) gear 15 and a final (second) gear 16. The pinion gear 14 is fixed to a motor shaft 13 of the motor M. The motor shaft 13 corresponds to a rotation shaft or an output shaft. The middle gear 15 is rotated by being engaged with the pinion gear 14, and the final gear 16 is rotated by being engaged with the middle gear 15.

The converter has a plate cam 17, a follower 19 and a pivot 20. The plate cam 17 integrally rotates with the final gear 16. The follower 19 is movably inserted into a cam groove 18 of the plate cam 17. The pivot pin 20 rotatably supports the follower 19.

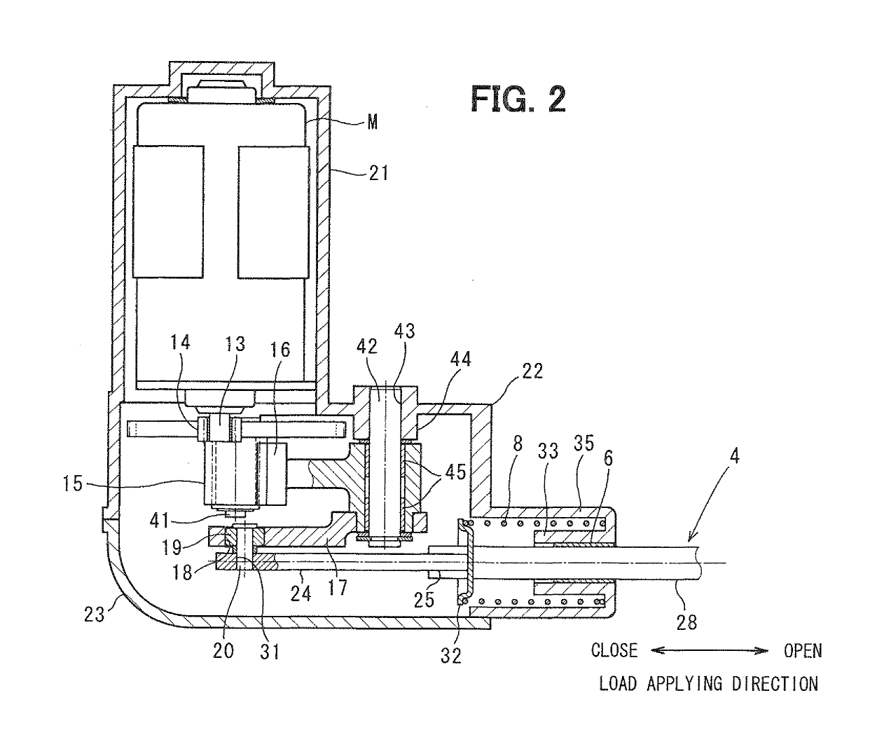

As shown in FIG. 2, the actuator case has a motor housing 21, a gear housing 22 and a cover 23. The motor housing 21 accommodates the motor M, and the gear housing 22 accommodates the deceleration mechanism and the converter. The cover 23 closes an opening of the gear housing 22. The motor housing 21 and the gear housing 22 are made with metallic material. The cover 23 is made with metallic material or resin material.

The rod 4 extends straightly in the load applying direction corresponding to the axis direction. As shown in FIG. 1, the rod 4 has a first rod 24, a second rod 26, and a connection rod 28. The first rod 24 having a plate shape is connected to the plate cam 17 through the follower 19 and the pivot pin 20. The second rod 26 having a plate shape corresponds to an output unit, and is connected to the waste gate valve 1 through the link lever 3 and the hinge pins 11, 12. The connection rod 28 having a circular cross-section corresponds to a relay part, and connects a first connector 25 of the first rod 24 to a second connector 27 of the second rod 26. The first rod 24, the second rod 26, and the connection rod 28 are integrated with each other by welding, for example.

The first rod 24 is an input unit which receives a load from the plate cam 17 through the follower 19 and the pivot pin 20. As shown in FIG. 2, an end portion of the first rod 24 opposite from the first connector 25 has a fitting hole 31 into which the pivot pin 20 is inserted. The pivot pin 20 passes through and protrudes from the first rod 24, and is fixed and connected to the first rod 24. The first connector 25 is connected to the connection rod 28 in the axis direction by welding.

The second rod 26 is an output unit which outputs the load received from the plate cam 17 into the shaft 2 of the waste gate valve 1 through the link lever 3 and the hinge pins 11, 12. An end portion of the second rod 26 opposite from the second connector 27 has a fitting hole (not shown) into which the first hinge pin 11 is inserted. The first hinge pin 11 passes through and protrudes from the second rod 26, and is fixed and connected to the second rod 26. The second connector 27 is connected to the connection rod 28 in the axis direction by welding.

The connection rod 28 is slidably supported by the bearing 6. A ring-shaped spring seat 32 is defined around an outer periphery of the connection rod 28, and receives a load from the spring 8 in the load applying direction, so that the valve 1 is totally closed, as shown in FIG. 1.

A cylindrical bearing holder 33 is located adjacent to a side wall of the gear housing 22, and opposes to the valve 1 in the axis direction. A bearing hole 34 is defined in the bearing holder 33, and passes through the holder 33 in the axis direction. The bearing 6 is pressed and fitted into the bearing hole 34, and slidably supports the connection rod 28 in the load applying direction. A through hole (slide hole) is defined to pass through the bearing 6 in the axis direction.

The coil spring 8 is elastically accommodated in a cylindrical spring holder 35 protruding toward the valve 1 from the side wall of the gear housing 22. The coil spring 8 is a rod (valve) biasing portion that generates a biasing force (load) biasing the rod 4 in a direction of closing the valve 1. The coil spring 8 has a first end supported by the spring seat 32 of the connection rod 28, and a second end supported by a ring-shaped separation wall 36. The separation wall 36 is closed, and connects an end of the bearing holder 33 to an end of the spring holder 35. A spring load is applied from the coil spring 8 onto the first rod 24, so as to totally close the valve 1.

The electric motor M is a power source for activating the electric actuator, and generates driving force (motor torque) in response to electric power supplied to the motor M. The electric motor M is accommodated in a motor space of the motor housing 21, and is controlled by an electronic control unit (ECU). The ECU has a known microcomputer including CPU, ROM and RAM. The ECU controls electric actuators of the throttle valve and the waste gate valve 1 based on signals output from a stroke sensor, a crank angle sensor, an accelerator opening sensor, a throttle opening sensor, a supercharging pressure sensor, and a speed sensor, for example.

The stroke sensor detects a stroke amount of the rod 4. A magnet and a yoke are mounted to a member integrally moving with the rod 4. A through hole (slide hole) is defined to pass through the magnet. The stroke sensor may not be mounted in the gear housing 22. A single Hall element or a magnetoresistive element (MR element) may be used as a non-contact type magnetic sensing element, instead of a hole IC.

The deceleration mechanism is a power transmission device which transmits the torque of the electric motor M to the converter. The deceleration mechanism is constructed by the pinion gear 14, the middle gear 15, and the final gear 16. As shown in FIG. 2, the deceleration mechanism has a first supporting shaft 41 (middle gear shaft) and a second supporting shaft 42 (final gear shaft). The shaft 41, 42 extends approximately parallel to the motor shaft 13 of the electric motor M. The shafts 41, 42 extend parallel with each other. The gears 14, 15, 16 are rotatably accommodated in a gear space of the gear housing 22.

The first shaft 41 is fixed to a first fitting part (not shown) of the gear housing 22 by being fitted into a first fitting hole (not shown) of the gear housing 22. A center axis of the shaft 41 corresponds to a rotation center of the middle gear 15.

The shaft 41 has a protrusion protruding from an end face of the middle gear 15, and a circular slot is defined around the protrusion in a circumference direction. A washer and a C-ring are mounted to the slot, so that the middle gear 15 is restricted from separating from the shaft 41 when the middle gear 15 is fitted to the outer periphery of the shaft 41.

The second shaft 42 is fixed to a second fitting part 44 of the gear housing 22 by being fitted into a second fitting hole 43 of the gear housing 22. A center axis of the shaft 42 corresponds to a rotation center of the final gear 16. The final gear 16 is rotatably supported around the outer periphery of the shaft 42 through two bearings 45. The shaft 42 has a protrusion protruding from an end face of the final gear 16, and a circular slot is defined around the protrusion in a circumference direction. A washer and a C-ring are mounted to the slot, so that the final gear 16 is restricted from separating from the shaft 42 when the final gear 16 is fitted to the outer periphery of the shaft 42.

The pinion gear 14 is made of metallic material or resin material, and is fixed to an outer periphery of the motor shaft 13 by fitting. As shown in FIG. 1, teeth 51 are defined around an outer periphery of the pinion gear 14 all over the circumference direction, and are engaged with the middle gear 15.

The middle gear 15 is made of metallic material or resin material, and is rotatably fitted with an outer periphery of the first shaft 41. The middle gear 15 has a cylindrical portion to surround the shaft 41 in the circumference direction. A ring-shaped large diameter part is integrally defined around the outer periphery of the cylindrical portion, and a diameter of the large diameter part is the maximum in the middle gear 15.

Teeth 52 are defined around an outer periphery of the large diameter part of the middle gear 15 all over the circumference direction, and are engaged with the teeth 51 of the pinion gear 14. Further, as shown in FIG. 3, teeth 53 are defined around an outer periphery of the cylindrical portion all over the circumference direction, and are engaged with the final gear 16. The cylindrical portion corresponds to a small diameter part. The teeth 52 correspond to a gear portion of the large diameter part, and the teeth 53 correspond to a gear portion of the small diameter part.

The final gear 16 is made of metallic material or resin material, and is rotatably fitted with an outer periphery of the second shaft 42 through the two bearings 45. The final gear 16 has a cylindrical portion to surround the second shaft 42 in the circumference direction. As shown in FIG. 1, the cylindrical portion has a flange 54 which spreads in a fan shape from a peripheral surface of the cylindrical portion.

Teeth 55 are defined on an outer periphery of the flange 54 of the final gear 16 having a predetermined angle corresponding to the fan shape, and are engaged with the teeth 53 of the middle gear 15. The teeth 55 correspond to a gear portion of a fan-shaped large diameter part of the final gear 16.

A rotating movement of the final gear 16 is converted into a linear movement of the rod 4 by the converter to convert a movement direction. The converter has the plate cam 17, the follower 19 and the pivot pin 20. The plate cam 17 rotates integrally with the final gear 16, and a rotation center of the cam 17 corresponds to the second shaft 42. The follower 19 is movably disposed in the cam groove 18 of the plate cam 17. The pivot pin 20 rotatably supports the follower 19.

The plate cam 17 having a predetermined shape is made with metallic material, and is fixed to a cam holder of the final gear 16. If the final gear 16 is made with resin material, the plate cam 17 is produced by performing an insert-molding relative to the final gear 16. If the final gear 16 is made with metallic material, the final gear 16 and the plate cam 17 may be integrated with each other by sintering metal, for example. Thus, a rotation shaft of the last gear 16 and a rotation shaft of the plate cam 17 are made common, so that a rotation center of the final gear 16 and a rotation center of the second shaft 42 are coincident with a rotation center of the plate cam 17. Further, an operating angle of the final gear 16 is equal to a rotation angle of the plate cam 17.

The cam groove 18 of the plate cam 17 is a guide part having a curve shape corresponding to an operation pattern of the waste gate valve 1. The plate cam 17 has an outside part 61 and an inside part 62. The outside part 61 is located outside of the cam groove 18 in a radial direction of the plate cam 17. The inside part 62 is located inside of the cam groove 18 in the radial direction.

As shown in FIG. 3, an end of the cam groove 18 corresponding to the totally-closed position has a restricting wall 63. The wall 63 extends semi-circularly to connect the outside part 61 to the inside part 62, and restricts the follower 19 from further moving in the closing direction.

As shown in FIG. 1, an end of the cam groove 18 corresponding to the totally-opened position has an opening 64 open outward in a rotating direction of the plate cam 17. A bridge 65 is defined to connect the outside part 61 to the inside part 62, so that a strength of the plate cam 17 is enhanced. The bridge 65 is located at a position not interfering with the follower 19 and the pivot pin 20, while the bridge 65 is located adjacent to one side of the follower 19 and the pivot pin 20 in their axis direction.

The follower 19, the pivot pin 20, and the rod 4 may separate from the cam groove 18 when the waste gate valve 1 is totally opened while the engine is active. Therefore, a stopper is mounted to the gear housing 22 so as to restrict the final gear 16 or the cam 17 from further moving in a direction of opening the valve 1 after the follower 19, the pivot pin 20, and the rod 4 are mounted to the cam groove 18. A shape and a rotation angle of the plate cam 17 are suitably set relative to a stroke amount of the rod 4 necessary for driving the valve 1 between the totally-closed position and the totally-opened position.

The follower 19 having a cylindrical shape is made with metallic material, and is rotatably fitted with an outer periphery of the pivot pin 20. The follower 19 has a cylindrical portion to surround the pivot pin 20 in a circumference direction. The pivot pin 20 is fixed to the rod 4 by being pressed into the fitting hole 31 of the rod 4. The pivot pin 20 has a protrusion protruding from an end face of the cylindrical portion of the follower 19, and has a flange defined by swaging the protrusion so as to prevent the separation of the follower 19. A center axis of the pivot pin 20 corresponds to a rotation center of the follower 19. The rotation center of the follower 19 is located on the load applying direction together with the rotation center of the plate cam 17.

Operation of the electric actuator to drive the waste gate valve 1 will be described with reference to FIGS. 1-4.

If a supercharging pressure detected by a supercharging pressure sensor is smaller than a predetermined value, the ECU controls electricity supplied to the motor M so as to totally close the valve 1, as shown in FIGS. 1 and 2. The valve 1 is maintained to be totally closed, thereby closing the waste gate passage. All of gas exhausted from the engine flows into the turbine housing so as to rotate the turbine impeller, and is discharged out of the turbine housing. In contrast, air drawn into the intake pipe is compressed by the compressor impeller which is driven by the rotation of the turbine impeller, so that the supercharging pressure is increased. The compressed air is drawn into the engine.

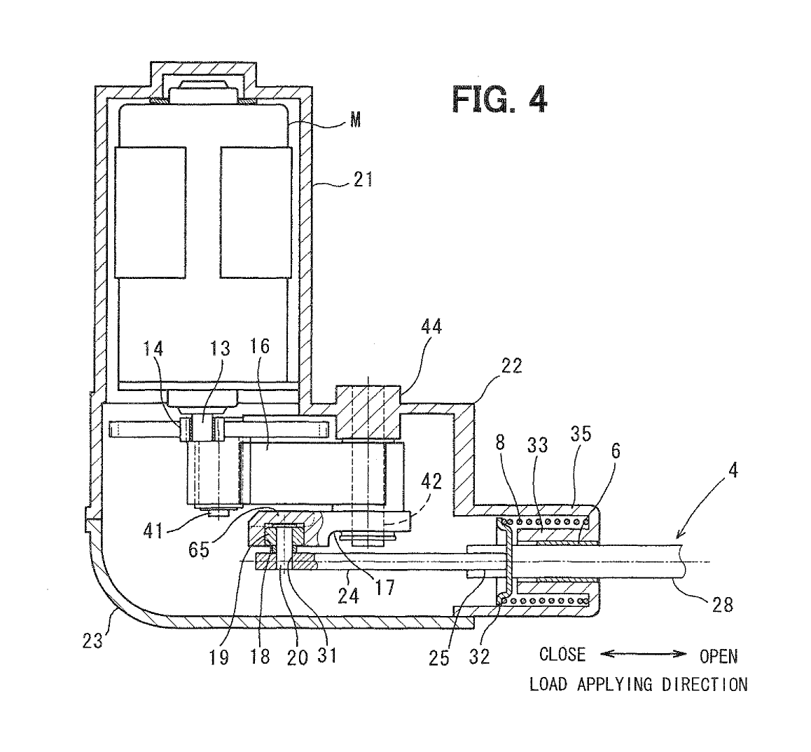

If the supercharging pressure becomes equal to or larger than the predetermined value, the ECU controls the electricity supplied to the motor M so as to totally open the valve 1, as shown in FIGS. 3 and 4. The motor shaft 13 of the motor M is rotated in a valve opening direction, and the motor torque is transmitted from the motor M to the gears 14, 15, 16. When the motor torque is transmitted from the final gear 16 to the plate cam 17, the plate cam 17 rotates in a valve opening direction by a predetermined angle in accordance with the rotation of the final gear 16. The predetermined angle is equal to an operation angle of the final gear 16.

At this time, the pivot pin 20 slides in the cam groove 18 from the totally-closed position to the totally-opened position, and the rod 4 linearly moves in a direction of opening the valve 1 in the load applying direction, so that the rod 4 compresses the coil spring 8. The first hinge pin 11 linearly moves in the valve opening direction in the load applying direction in accordance with the linear movement of the rod 4, and the link lever 3 rotates in the valve opening direction with respect to the second hinge pin 12. The valve 1 rotates in the valve opening direction with respect to the second hinge pin 12 in accordance with the rotation of the second hinge pin 12. Thus, the valve 1 is separated from the valve seat, and is totally opened, so that the waste gate passage is opened and released.

A part of exhaust gas flowing into the turbine housing from the engine flows in the waste gate valve bypassing the turbine impeller, and flows out of the turbine housing. Because energy of exhaust gas applied to the turbine impeller is decreased, a rotation speed of the turbine impeller is lowered, so that the turbocharger is prevented from having excessive rotation. Therefore, the turbine impeller is prevented from being damaged. Further, the supercharging pressure or the exhaust gas pressure is prevented from becoming excessive.

If the supercharging pressure becomes smaller than the predetermined value, the ECU controls the electricity supplied to the motor M so as to totally close the valve 1. The motor shaft 13 of the motor M is rotated in a valve closing direction, and the motor torque is transmitted from the motor M to the gears 14, 15, 16 and the plate cam 17. The plate cam 17 rotates in a valve closing direction by a predetermined angle in accordance with the rotation of the final gear 16.

The pivot pin 20 slides in the cam groove 18 from the totally-opened position to the totally-closed position, and the rod 4 linearly moves in a valve closing direction in the load applying direction. The first hinge pin 11 linearly moves in a valve closing direction in the load applying direction in accordance with the linear movement of the rod 4, and the link lever 3 rotates in a valve closing direction with respect to the second hinge pin 12. The valve 1 rotates in a valve closing direction with respect to the second hinge pin 12 in accordance with the rotation of the second hinge pin 12. The valve 1 is seated on the valve seat, and is totally closed, so that the waste gate passage is closed.

Generally, when the valve 1 is totally closed or opened, a valve reaction force is generated from the rod 4. Specifically, a side face of the follower 19 presses a side face of the cam groove 18 through the pivot pin 20 of the rod 4. The valve reaction force corresponds to a load applied from the rod 4, when the motor M is driven to totally close or open the valve 1.

If the valve reaction force is applied to the plate cam 17 in a direction of closing or opening the valve 1, the plate cam 17 may rotate in the valve closing direction or the valve opening direction. However, when the valve 1 is totally closed or opened, the plate cam 17 is required to be restricted from rotating. Therefore, much motor current is necessary for maintaining the valve 1 at the totally-opened position or the totally-closed position.

According to the first embodiment, when the valve 1 is totally closed or opened, a center axis RC of the rod 4 corresponding to the load applying direction is approximately perpendicular to a common tangent T of a contact face between which the side face of the plate cam 17 and the side face of the follower 19 are contact with each other.

Further, a rotation center CO of the cam 17 and a rotation center FO of the follower 19 are located on the center axis RC.

Further, the follower 19, the rotation center CO of the cam 17 and the connection rod 28 are arranged in this order in the load applying direction, from left to right in FIGS. 1 and 3. That is, the follower 19, the rotation center CO of the cam 17 and the connection rod 28 are arranged in this order toward the valve 1 in the load applying direction.

When the valve 1 is totally opened or closed, a pressing force is applied from the follower 19 onto the side face of the cam groove 18, so that a load is generated for the engine from the rod 4. However, because the load applying direction corresponding to the center axis RC of the rod 4 is perpendicular to the common tangent T of the contact face between the side face of the plate cam 17 and the side face of the follower 19, the cam 17 is not rotated even if the load corresponding to the valve reaction force is transmitted from the rod 4 to the cam 17.

Therefore, when the valve 1 is totally opened or closed, the motor current necessary for holding the valve 1 at the totally-opened position or the totally-closed position against the valve reaction force can be reduced, so that the consumption power can reduced.

When the electric actuator is used for driving the waste gate valve 1, the valve 1 is frequently opened or closed between the totally-closed position and the totally-opened position. However, the consumption electricity can be reduced when the valve 1 is totally opened or closed.

As shown in FIGS. 1 and 3, a first linear line L1 is defined to connect the rotation center CO of the cam 17 to the rotation center FO of the follower 19. A second linear line L2 is defined to connect the rotation center CO of the cam 17 to a rotation center CGO of the middle gear 15. The first linear line L1 and the second linear line L2 are approximately coincident with each other. The teeth 53 of the middle gear 15 and the teeth 55 of the final gear 16 are engaged with each other on the second linear line L2.

If a rotation shaft of the final gear 16 and a rotation shaft of the plate cam 17 are made of a common component, an operation angle of the final gear 16 becomes equal to a rotation angle of the plate cam 17. At this time, because the first linear line L1 and the second linear line L2 are approximately coincident with each other, an operation path of the final gear 16 is approximately coincident with an operation path of the plate cam 17. Therefore, a size of the electric actuator can be made smaller compared with a case where the operation path of the final gear 16 is different from the operation path of the plate cam 17. Thus, the electric actuator can be easily mounted to an engine compartment of a vehicle.

The plate cam 17 has the groove 18 having the curve shape corresponding to the operation pattern of the valve 1. The end of the groove 18 corresponding to the totally-opened position is exposed or released outward in the rotation direction of the cam 17.

The end of the groove 18 corresponding to the totally-opened position is open by cutting and removing. The follower 19 mounted to the pivot pin 20 can be easily inserted into the groove 18 by turning over the plate cam 17 in the valve opening direction while the rod 4 is inserted into the bearing 6. The rod 4 having the pivot pin 20 and the follower 19 can be easily assembled to the plate cam 17 that is integrally mounted to the final gear 16, so that a producing cost of the electric actuator can be restricted from increasing.

If the end of the groove 18 corresponding to the totally-opened position is cut, the strength of the cam 17 is lowered on the cut side. Therefore, the bridge 65 is arranged to connect the outside part 61 to the inside part 62 on the cut side, so that the strength of the plate cam 17 is increased on the cut side. The bridge 65 is located at a position not interfering with the follower 19 and the pivot pin 20. Alternatively, the bridge 65 may be arranged in all area of the cam groove 18.

### Second Embodiment

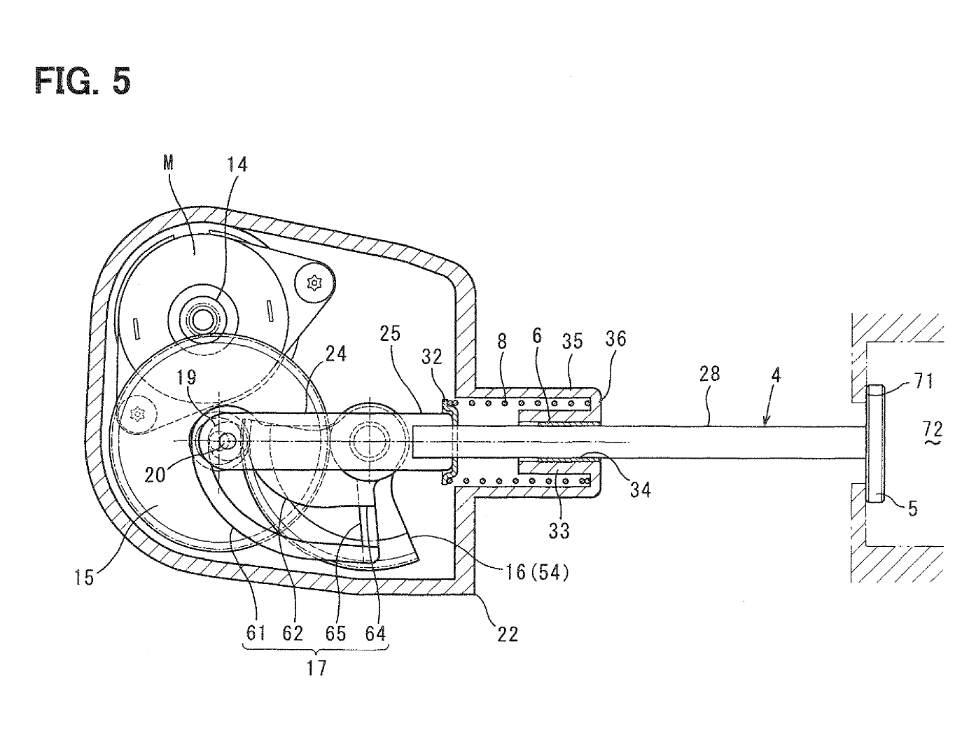

A second embodiment will be described with reference to FIG. 5. In the second embodiment, an electric actuator drives an exhaust gas recirculation (EGR) valve 5.

The engine has an EGR device having an EGR pipe. A part of EGR gas is recirculated from an exhaust pipe to an intake pipe through the EGR pipe, so as to reduce toxic substance such as NOx contained in exhaust gas. A flow rate controlling valve is arranged in the EGR pipe, and controls a flow rate of exhaust gas. The controlling valve has the EGR valve 5 to control a flow rate of EGR gas flowing inside of the EGR pipe, and an electric actuator to open or close the valve 5 in accordance with a stroke amount of the rod 4.

A valve seat 71 is defined inside of the EGR pipe, and the valve 5 is seated on or separated from the valve seat 71 so as to close or open an EGR gas passage 72.

The electric actuator includes the rod 4, the motor M, the gears 14, 15, 16, the plate cam 17, the follower 19, the pivot pin 20, the bearing 6, the coil spring 8, the housings 21, 22 and the cover 23, similarly to the first embodiment.

The rod 4 is constructed by a first rod 24 and a connection rod 28. The valve 5 is connected to a tip end of the rod 28 in the axis direction. The valve 5 is a poppet valve arranged on a tip end of the rod 4 in the axis direction corresponding to the load applying direction. The valve 5 has a disk shape, and a back face of the valve 5 is to be seated on the valve seat 71.

The controlling valve may be arranged at a branch defined between the exhaust passage of the exhaust pipe and the EGR gas passage 72 of the EGR pipe. Alternatively, the controlling valve may be arranged at a joint defined between the intake passage of the intake pipe and the EGR gas passage 72 of the EGR pipe.

### (Modification)

The valve driving device of the present invention may be applied to an electric actuator for controlling a capacity-changeable turbocharger.

The end of the cam groove 18 corresponding to the totally-opened position is released outside. Alternatively, the other end of the cam groove 18 corresponding to the totally-closed position may be released outside.

The valve driving device may drive other valve having a valve structure other than the hinge valve 1 or the poppet valve 5. The valve driving device may be used as an electric actuator for controlling a flow rate of fluid, other than the EGR valve 5. For example, an opening degree of the valve 1 may be continuously or stepwise changed, thereby controlling the supercharging pressure by changing a flow rate of exhaust gas flowing through the waste gate passage. The engine may be a gasoline engine other than the diesel engine.

The valve reaction force applied from the rod 4 is prevented from acting on the cam 17 in the rotating direction by raising the link efficiency when the valve is totally closed or opened. Specifically, the center axis RC of the rod 4 corresponding to the load applying direction is perpendicular to the tangent T of the contact face between which the side face of the plate cam 17 and the side face of the follower 19 are contact with each other. Further, the rotation center CO of the cam 17 and the rotation center FO of the follower 19 are located on the center axis RC. Further, the follower 19, the rotation center CO of the cam 17 and the connection rod 28 are arranged in this order toward the valve 1 in the load applying direction.

The deceleration mechanism decelerates the rotation of the motor M so as to have a predetermined reduction ratio, and may be a multi-step deceleration mechanism having a worm gear, helical gear, spur gear or output gear, for example.

Such changes and modifications are to be understood as being within the scope of the present invention as defined by the appended claims.

What is claimed is:

1. A valve driving device to open or close a valve comprising:
a motor;
a deceleration mechanism to slow down a rotation of the motor;
a cam to be rotated with a rotation of the deceleration mechanism, the cam having a cam groove having a predetermined shape corresponding to an operation pattern of the valve;
a follower movably fitted in the cam groove; and
a rod having a pivot rotatably supporting the follower, the rod having a first end connected to the cam through the follower and the pivot, and a second end connected to the valve, wherein
the rod reciprocates in an axis direction, and applies a load to the valve in a load applying direction corresponding to the axis direction, and
the rod has a center axis approximately perpendicular to a tangent of a contact face between which the cam and the follower are contact with each other when the valve is totally closed or opened.

2. The valve driving device according to claim 1, wherein
the cam is rotated with respect to a rotation center,
the follower is rotated with respect to a rotation center, and
the rotation center of the cam and the rotation center of the follower are located on the center axis of the rod in the axis direction.

3. The valve driving device according to claim 1, wherein
the deceleration mechanism has a first gear to be rotated by the motor, and a second gear to be rotated by engaging with the first gear.

4. The valve driving device according to claim 2, wherein
the follower, the rotation center of the cam, and the rod are arranged in this order toward the valve in the load applying direction.

5. The valve driving device according to claim 3, wherein
a first linear line is defined to connect a rotation center of the cam to a rotation center of the follower,
a second linear line is defined to connect the rotation center of the cam to a rotation center of the first gear, and
the first linear line and the second linear line are approximately coincident with each other.

6. The valve driving device according to claim 1, further comprising:
a rod bearing to support the rod in the load applying direction.

7. The valve driving device according to claim 6, wherein
the valve is totally opened when the follower is located at a first end of the cam groove,
the valve is totally closed when the follower is located at a second end of the cam groove opposite from the first end, and
the first end or the second end of the cam groove is released outward in a rotating direction of the cam.

8. The valve driving device according to claim 7, wherein
the cam has
an outside part located outside of the cam groove in a radial direction of the cam,
an inside part located inside of the cam groove in the radial direction, and
a bridge connecting the outside part to the inside part.

9. The valve driving device according to claim 1, further comprising:
a link mechanism arranged between the rod and the valve, the link mechanism converting a linear movement of the rod into a rotating movement of the valve, wherein
the link mechanism has a lever connecting the rod to the valve,
the rod has a first hinge pin rotatably supporting the lever,
the valve has a second hinge pin rotatably supporting the lever, and
the valve is a hinge valve connected to a tip end portion of the rod in the load applying direction through the first hinge pin, the lever and the second hinge pin.

10. The valve driving device according to claim 1, wherein
the valve is a poppet valve arranged on a tip end portion of the rod in the load applying direction.
